(19) United States
(12) Patent Application Publication
(10) Pub. No.: US 2014/0358577 A1
(43) Pub. Date: Dec. 4, 2014

(54) SOFTWARE FOR MEDICAL PRACTITIONERS

(71) Applicant: Quality Health Ideas LLC, Wilbraham, MA (US)

(72) Inventor: Philip F. Gaziano, Wilbraham, MA (US)

(73) Assignee: Quality Health Ideas LLC, Wilbraham, MA (US)

(21) Appl. No.: 14/291,731

(22) Filed: May 30, 2014

Related U.S. Application Data
(60) Provisional application No. 61/828,855, filed on May 30, 2013.

(51) Int. Cl. G06Q 50/22; G06Q 40/00

(52) U.S. Cl. CPC G06Q 50/22; G06Q 40/12
USPC 705/2

(57) ABSTRACT

Applicant has disclosed a method to provide (via software) medical practitioners, medical directors, medical administrators and insurers continuously updated and digitally-generated statistical information, displayed as screen displays, related to the frequency of use and completeness of implementation of medical software. This auditing, in-turn, allows medical practitioners and other interested parties to ensure health care is provided in a complete, systematic, and effective manner that both maximizes provider revenue and minimizes insurance costs while resulting in healthier patients. In a preferred embodiment, this method comprises: continuously and automatically auditing the extent to which a medical practitioner utilizes or enters data in a digital Superbill, in the course of treating patients, by displaying digitally-generated, color-coded, audit results as screen displays to medical directors and medical practitioners, wherein different colors indicate different extents of Superbill usage.

### RELATED APPLICATION

This application claims priority to U.S. Provisional Patent Application Ser. No. 61/828,855, entitled “SOFTWARE FOR MEDICAL PRACTITIONERS,” filed May 30, 2013. Applicant claims priority from that application. Applicant also hereby incorporates by reference that application in its entirety.

### FIELD OF INVENTION

This invention relates in general to medical recordkeeping and billings. More particularly, it relates to automated auditing and analysis of computerized medical records including billing records.

### BACKGROUND OF THE INVENTION

This application relates to U.S. Pat. No. 8,321,244 to Philip F. Gaziano, for “Software System for Aiding Medical Practitioners and Their Patients” issued Nov. 27, 2012. The patented software system is part of the CareScreen™ software, offered as an on-demand service.

The present invention is a software adjunct that enhances the functionality of the electronic recordkeeping system described in U.S. Pat. No. 8,321,244, by providing a high level audit and analysis function whereby the performance of those using the CareScreen™ software can be monitored and improved. The function performed by the invention is similar to, but better than, audits performed by a medical director or a medical administrator.

As described in U.S. Pat. No. 8,321,244, medical practitioners use that software to enhance patient encounters. The term “medical practitioners”, as used herein, describes physicians (“MDs”), nurse practitioners (“NPs”) and physician assistants (“PAs”) at any location known for providing medical services, such as a doctor's office, a doctor's group, or a hospital or an outpatient clinic.

CareScreen™ software helps keep medical practitioners from missing potential problems by prompting them to examine and treat all applicable medical conditions based upon their examination and upon previously acquired electronic patient data. CareScreen™ software best accomplishes its designed purposes when used routinely, frequently, and consistently, by medical practitioners. It is slightly less effective when office staff members enter data as opposed to when medical practitioners make the entries directly, and of course, it is ineffective when not used. The inventive software provides statistics enabling interested parties to monitor the frequency and pattern of use of CareScreen™ software by medical practitioners and their staffs.

The benefits of software assisted patient interaction include assisting medical practitioners to perform exhaustive examinations and to follow up on all medical conditions known to affect or potentially to affect patients. It also includes enhancing revenue production by ensuring that medical practitioners do not overlook conditions worthy of examination, and it helps to ensure that services provided do not escape billing. The systematic approach also improves the quality of service by standardizing care.

Both CareScreen™ and Virtual Medical Director™ software deal in part with medical practitioners' use of Superbills.

The term “Superbill” (a.k.a. “superbill”) refers to a type of form (at least in the United States) used by healthcare providers to list services for the purpose of generating an invoice or insurance claim. Such forms offer a standardized method for quickly noting itemized services and transferring them to patient records. They are also used in some veterinary practices to streamline billing and payment, which often rely on systems similar to those used in human medicine. This term is also used to refer to a highly accurate and detailed counterfeit bill that may evade detection by conventional means.

Health care providers use generic forms for Superbills. They are broken up into a number of categories by service type, with a listing of common services. Providers may have multiple forms for different kinds of consultations, to ensure that they are able to accurately record the services rendered. They check boxes on the Superbill applicable to the visit like “recheck exam” and “glucose check” for a patient with diabetes stepping into the office for a quick examination and blood sugar evaluation.

These documents typically have a space at the top with provider information, including the care provider's name, address, and medical license number. Care providers can also list insurance identification numbers and other relevant data on the Superbill. The patient's information is recorded, sometimes with the use of a sticker applied to the document by a receptionist or nurse, depending on how a practice is organized. Date, time, and location of the services are also noted for convenience.

Each entry on a Superbill can be matched against a medical code used by insurance providers to standardize the claims process. Instead of listing a procedure, for example, physicians list the applicable codes for the procedure and accompanying services like injections and medications. By using a standardized form to record services at the time of the visit, care providers can transfer the information easily into a medical billing system that can convert internal codes to the appropriate ones for insurance billing.

Copies of Superbills can be retained in patient files along with copies of the bills generated with the use of the document. These are available for review if patients have questions or concerns. It can be advisable to closely check each line item on the Superbill to make sure each listed service was actually provided. Any disputes can be brought up with the billing office to resolve the problem before making a payment or appealing an insurance denial, if the bill was sent directly to the insurance company.

Electronic recordkeeping has many advantages over older manual methods. The present software promotes the use of electronic recordkeeping by tracking its use, and by keeping medical professionals informed as to how well and how often electronic recordkeeping is being implemented, and whether improvements are needed.

It is a primary object of the present invention to provide feedback to users on performance by providing customizable, easy to read feedback on CareScreen™ system usage, allowing users (i.e., medical providers) to modify their behaviors and provide better care to their patients.

It is another object to provide customizable color coding for fast user feedback, indicating different levels of CareScreen™ performance.

It is a more specific object of the present invention to automatically analyze each medical provider's use of CareScreen™ software by comparing the number of encounters logged in the CareScreen™ software to the total number of patient invoices tendered to the relevant insurance companies.

It is another object of the present invention to provide software which can automatically determine the extent to which medical practitioners initiate the Superbill as opposed to those initiated by office staff.

### SUMMARY OF THE INVENTION

Applicant has disclosed a software enhancement to the “Software System for Aiding Medical Practitioners and Their Patients” described in U.S. Pat. No. 8,321,244 issued to Philip F. Gaziano. The patented software system is part of CareScreen™ software, offered as an on-demand service.

The enhancement implements audit functions in CareScreen™ software for a facility medical director or medical administrator to monitor and improve medical practitioner and medical group performance. The present invention, nicknamed CareScreen™ Virtual Medical Director™ or “CSVMD”, automatically monitors the extent to which medical practitioners and their staffs apply CareScreen™ software in their practices. It does so by comparing insurer records of billings for medical visits with digital records of patient encounters initiated in the medical practitioner's office. It makes available a number of reports showing the percentage of patient encounters in which medical practitioners and their staffs made use of CareScreen™ Software.

When used, CareScreen™ software improves the quality of medical services offered by medical providers, improves medical-provider profits by ensuring all opportunities to provide medical attention are pursued and invoiced, and it reduces insurance costs by ensuring that patient conditions are addressed at the earliest possible stage. Consequently, the more consistently CareScreen™ software is applied, the more positively it influences the medical practice.

The CSVMD provides customizable, easy to read feedback on CareScreen™ system usage, allowing users (i.e., medical providers) to modify their behaviors and provide better care to their patients. The CSVMD will be included in the existing CareScreen™ application.

Provider level fields will be displayed with measurable customizable color coding for fast user reference. Applicant's CSVMD invention currently uses five levels: the color red indicates worst below a benchmark (a.k.a. goal); orange indicates significantly below the benchmark; yellow indicates below the benchmark; green indicates equal to or above the benchmark; and blue indicates significantly above the benchmark.

These levels can be customized depending on the quality measure being reflected. For instance, one medical group (e.g., a group of physicians specializing) in rheumatology) could have the green benchmark at 70%, while a hospital could have the green benchmark at 50%.

These levels can also be customized for each software client. For instance, the green benchmark could be set at 70% for one hospital, while another hospital could have the green benchmark at 65%.

By providing a built-in auditing tool, the present invention allows insurance companies, medical directors, and medical practitioners to see at a glance the extent to which medical practitioners, medical groups, or members of insurance risk pools, apply the program.

### BRIEF DESCRIPTION OF THE DRAWINGS

The above and other objects will become more readily apparent when the following description is read in conjunction with the accompanying drawings in which:

FIG. 1 is a screen shot of one tab, of the Virtual Medical Director™ software, entitled “Actual Use” and showing login history in CareScreen™ software by medical providers;

FIG. 1A is an enlarged view of a Logins/YTD number displayed in red;

FIG. 1B is an enlarged view of another Logins/YTD number, higher than the FIG. 1A number, displayed in orange;

FIG. 1C is an enlarged view of another Logins/YTD number, higher than the FIG. 1B number, displayed in yellow;

FIG. 1D is an enlarged view of another Logins/YTD number, higher than the FIG. 1C number, displayed in green;

FIG. 1E is an enlarged view of another Logins/YTD number, higher than the FIG. 1D number, displayed in blue;

FIG. 2 is a screen shot of one tab, of the Virtual Medical Director™ software, entitled “YTD Usage” and showing one row for each applicable insurance company with the following additional information;

FIG. 3 is a screen shot of one tab, of the Virtual Medical Director™ software, entitled “HCCs Addressed” and addressing health chronic conditions;

FIG. 4 is a screen shot of one tab, of the Virtual Medical Director™ software, entitled “Functional Use, Encounters” and showing CareScreen™ encounters—provider usage versus staff usage;

FIG. 5 is a screen shot of one tab, of the Virtual Medical Director™ software, entitled “Functional Use, Registry”;

FIG. 6 is a flowchart showing the general flow of calculations used to achieve results shown in FIG. 1;

FIG. 7 is a flowchart showing the general flow of calculations used to achieve results shown in FIG. 2;

FIG. 8 is a flowchart showing the general flow of calculations used to achieve results shown in FIG. 3;

FIG. 9 is a flowchart showing the general flow of calculations used to achieve results shown in FIG. 4; and

FIG. 10 is a flowchart showing the general flow of calculations used to achieve results shown in FIG. 5.

### DETAILED DESCRIPTION OF THE PREFERRED EMBODIMENTS

Applicant's present invention, nicknamed Virtual Medical Director™ software, relates to U.S. Pat. No. 8,321,244 to Gaziano, entitled “Software System for Aiding Medical Practitioners and Their Patients,” issued Nov. 27, 2012. The patented software product of U.S. Pat. No. 8,321,244 is currently available as part of the CareScreen™ software program. Accountable Care Associates, Inc., headquartered in Springfield, Mass., offers CareScreen™ software as an on-demand service. CareScreen™ currently provides for web-based data sharing, reporting, management, insurance coding (for billing) and compliance tools.

Applicant also is the patentee of U.S. Pat. No. 8,321,244. Applicant hereby incorporates herein by reference that patent in its entirety.

By this application, Applicant is disclosing a method to enhance the CareScreen™ software system and third-party electronic medical billing software.

As used in this application, the following terms mean:
“Patients” are receivers of health care services who, if they have electronic medical records in a CareScreen™ database, are referred to herein CareScreen™ “members.” Note that by convention, the term “patient” is used during examination and treatment, and “member” is used otherwise;
“Staff Users” are members of medical practitioner and medical group office staffs that process CareScreen™ transactions, such as creating and maintaining patient accounts, printing Superbills, and entering post-exam data into CareScreen™ software. A staff user is assumed to have CareScreen™ credentials including a username and password;
“Medical Groups” are groups of medical practitioners working cooperatively in a group organization, usually in the same facility.
“Insurers” are (for the purposes of this application) insurance companies providing health insurance;
“Patient Panel” is (for the purposes of this application) a group of individuals who regularly receive medical care from a medical practitioner, medical group, or risk pool;
“Compliance Rate” is the number of times data from an encounter is entered into CareScreen™ software as compared with the overall number of encounters occurring;
“Participation Rate” is the percentage of times that a medical practitioner enters CareScreen™ data on encounter forms versus the number of times the data is entered by staff users;
“Registry” is a database that tracks the frequency and severity of the occurrence of measured medical phenomena; and
“Measure” is a parameter monitored and tracked by a registry;
“Risk Pool” is a collection of similar medical groups monitored by insurance companies. A medical group may participate in more than one risk pool; and
“Insurance Company Risk Groups” are groupings of medical practitioners usually similarly situated (i.e., treating the same illnesses generally, and similar in size and resources) and organized by insurance companies for the purpose of comparing performance and cost.

The more CareScreen™ software is used, the more it benefits patients, medical practitioners, medical groups, and Insurance Companies. The present invention—Virtual Medical Director™ software or “CSVMD” for short—tracks CareScreen™ software use and provides reports that promote improved performance.

As described in U.S. Pat. No. 8,321,244, CareScreen™ software keeps track of patient medical history and suggests areas of concern related to patient history and current symptoms to doctors immediately prior to patient encounters making time spent with patients more efficient, and avoiding overlooking important medical conditions. The software also keeps a record of each encounter, any follow-up required, patient medications, and it ensures complete billing for all encounters. The system uses the familiar Superbill format so medical practitioners have a relatively easy time converting from the old paper records to electronic recordkeeping. Although it is virtually always available, medical practitioners do not always use the electronic system opting instead to fall back on the old paper methods. In some cases, medical practitioners have their office staff personnel (“staff users”) make the electronic entries which results often in less faithful recording of information. The software promotes complete health care which benefits patients, medical practitioners, and insurance companies alike—increasing medical practitioner revenue, while decreasing overall health care costs by keeping patients healthier.

Obtaining the benefits of CareScreen™ software requires that it be faithfully and properly used. The present invention enhances the performance of CareScreen™ software: by automatically monitoring and auditing its use; and by providing insurers, medical group directors/administrators and medical practitioners with information on the use of the software enabling them to maximize its benefit. In essence, the inventive software tracks the performance of medical practitioners and provides performance-related feedback similarly, but better than, a medical director or administrator.

Unlike a medical director or medical administrator—who periodically (e.g., weekly, monthly or quarterly) calculates and distributes audit results to the medical practitioner, the present invention (CSVMD software) continuously and automatically audits the extent to which a medical practitioner uses a digital Superbill, in the course of treating patients, by displaying digitally-generated, color-coded, audit results as screen displays to the medical practitioners (and to the director or administrator) as screen displays, wherein different colors indicate different extents of use of the digital Superbill. This audit or review process is updated continuously, by the software.

In the preferred embodiment, CSVMD software also can provide information on how often a medical practitioner does and does not use CareScreen™ software. It tracks the number of uses of CareScreen™ as compared with the number patients in the medical practitioner's patient panel. It tracks the number of uses of CareScreen™ as compared with the number of encounter forms processed by applicable insurers. It also tracks the proportion of certain healthcare critical conditions that are addressed, and how often data is entered by staff users as opposed to medical practitioners. Finally, it assesses the degree to which certain important medical problems are reported to the registry tasked with accumulating information on such medical problems. In addition to tracking, the software provides reports showing, for each medical practitioner, medical group, and risk pool, their performance with respect to the monitored parameters and as compared to a pre-determined standard or “Best Practice”.

Best Practice, in each instance, is a preordained figure representing the percentage that is considered satisfactory. The value is arbitrarily assigned, typically by a medical director or a medical administrator though the web-based service for CareScreen™ software could assign the value also.

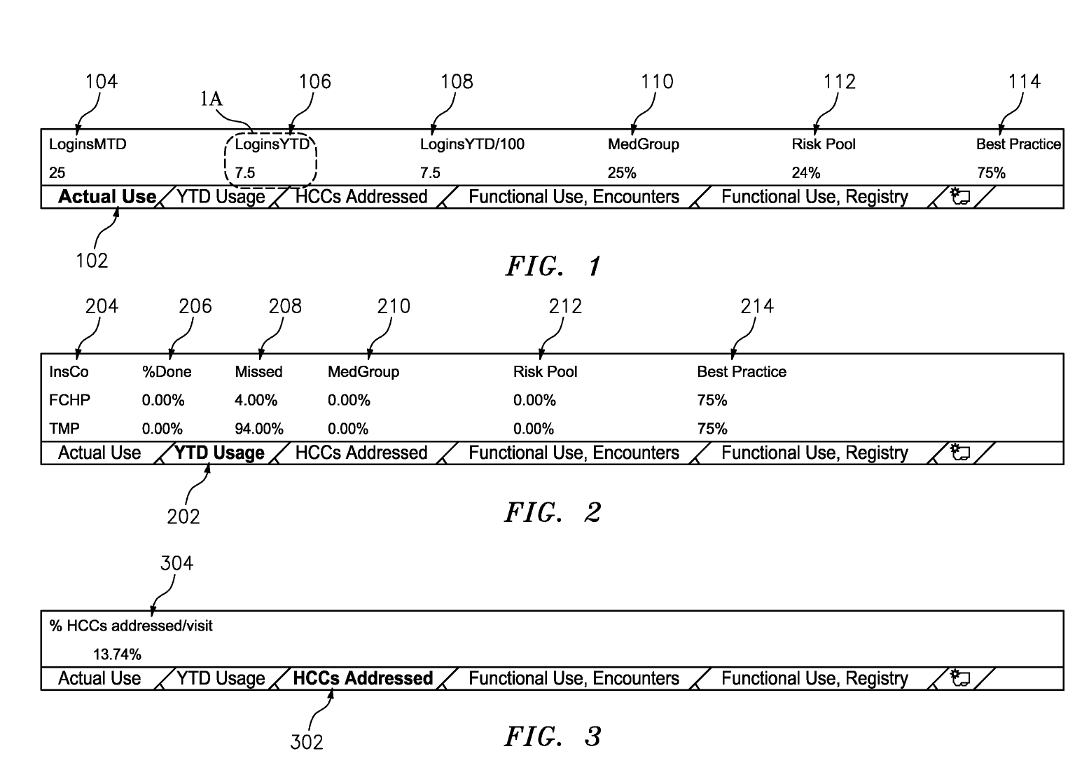

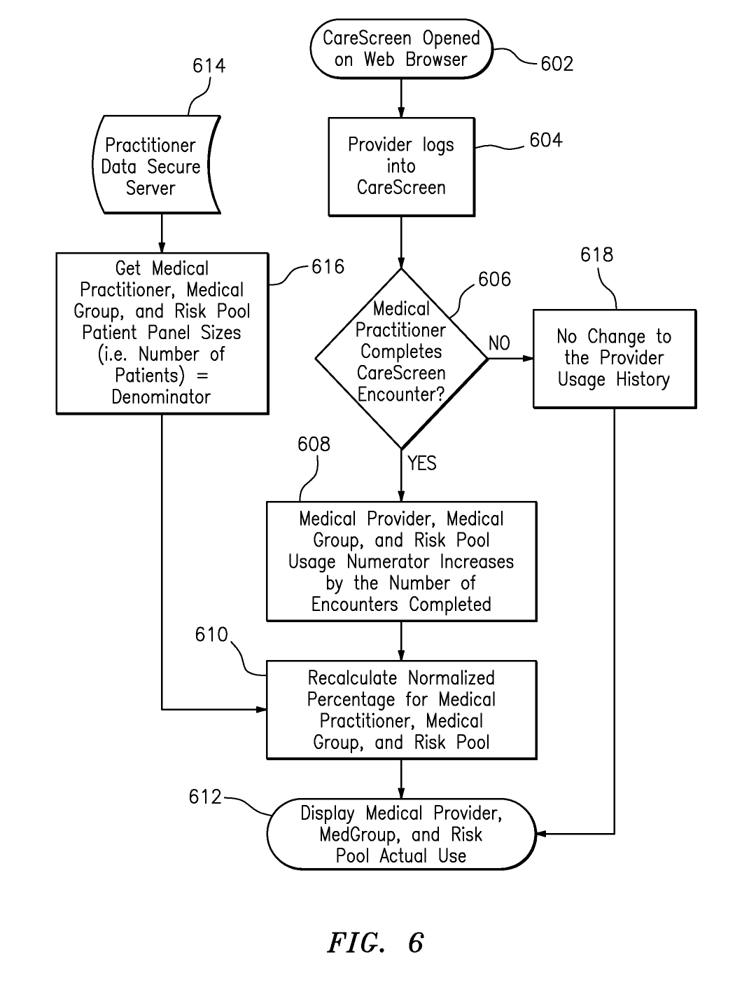

The following paragraphs describe, for each monitored parameter, the rationale for monitoring, and the method by which the monitored parameter is calculated and displayed. The reader's attention is called to FIG. 1 (relating to Login History). The general flow of calculations required for FIG. 1 is depicted as a flowchart on FIG. 6 (relating to Login History (Blocks 602-618)). The user accesses the information by clicking on the CSVMD “Actual Use” tab (referenced at 102). The first parameter in FIG. 1 is captioned “LoginsMTD” (referenced at 104). It displays the number of log-ins occurring during the current month.

The system assumes one encounter per login event. Since a login accompanies each encounter, the number of encounters can be tracked by counting the logins. Medical practitioners and their managers or administrators seek to achieve the highest possible number of logins. Tracking this parameter enables medical directors and insurance companies to compare medical practitioners, medical groups, and risk pools to one another.

The next parameter in FIG. 1 is captioned “LoginsYTD” (referenced at 106). This parameter is the same as LoginsMTD (referenced at 104), except that it provides the number of logins for the current year.

Parameter “LoginsYT/100” (referenced at 108) displays the number of log-ins as a percentage of the medical practitioner's patient panel (i.e., total number of patients) during the current year. It essentially tracks the number of encounters performed as compared with the size of the medical practitioner's patient panel. It provides insight into roughly how often a medical practitioner sees patients. For example, if a medical practitioner has one hundred patients in a panel, and the medical practitioner has fifty LoginsYTD (referenced at 106), then the LoginsYTD/100 (at 108) would be equal to 50% calculated according to the following formula:

LoginsYTD/100=L_YTD/P×100

Where:
L_YTD=Logins Year To Date for the medical practitioner; and
P=Patient Panel for the medical practitioner.

MedGroup 110 displays the number of log-ins as a percentage of the total number of patients in the medical group during the current year. That is the percentage derived by comparing the number encounters performed by all medical practitioners in the medical group with the total number of patients in all of the patient panels of all of the medical providers in the medical group—also called the medical group panel. MedGroup 110 shows how close medical practitioners in the medical group come to seeing all their patients in a given year. It is calculated as follows:

MedGroup=L_YTD/P×100

Where:
L_YTD=Logins Year To Date for all medical practitioners in the medical group; and
P=patient panel for all medical practitioners in the medical group.

Risk Pool 112 displays the number of log-ins as a percentage of the total number of patients in all medical groups within an insurance company risk pool. It is the calculation showing the percentage derived by comparing the number of encounters, performed by all medical practitioners in an insurance company risk pool, with the total number of patients in every patient panel of all medical practitioners. It shows how close medical practitioners in the risk pool come to seeing all their patients in a given year. It is calculated as follows.

Risk Pool=L_YTD/P×100

Where:
L_YTD=Logins Year To Date for all medical practitioners in the risk pool: and
P=Patient Panel for all medical practitioners in the risk pool.

Best Practice 114 displays a benchmark figure showing satisfactory Actual Use for the respective period. That is a preordained figure representing the percentage of the applicable panel (i.e., medical practitioner, MedGroup, or risk pool) considered satisfactory to have been seen at a given point in the year. The number is arbitrarily assigned and divided into twelfths, with an additional twelfth added in each month of the year. Each of the percentage values in FIG. 1, LoginsYTD/100 (referenced at 108), MedGroup 110, and Risk Pool 114 are displayed in a color corresponding to how each respective value compares with the best practice (a.k.a. benchmark or goal) as follows: the color red indicates worst below the benchmark; orange indicates significantly below the benchmark; yellow indicates below the benchmark; green indicates equal to or above the benchmark; and blue indicates significantly above the benchmark. This same color coding can be used for other auditing/monitoring categories as well.

These color levels (for any auditing/monitoring category) can be customized depending on the quality measure being reflected. For instance, one medical group (e.g., a group of physicians specializing in rheumatology) could have the green benchmark at 70%, while a hospital could have the green benchmark at 50%.

These levels can also be customized for each software client. For instance, the green benchmark could be set at 70% for one hospital, while another hospital could have the green benchmark at 65%.

Furthermore, the benchmarks can be both percentage based and integer based. For instance, the benchmarks could be measured on a percentage scale (1%-100%) for one type or field of CareScreen™ usage displayed, while the benchmarks for another field could be measured integer based (e.g., red=120 patient visits (a.k.a. patient encounters), orange=250 patients visits, yellow=375 visits).

For example, if the LoginsYT/100 for a particular medical practitioner's patient pool was: above 75%, then the number listed would be displayed in blue; between 65%-75% of the time, then the number would be displayed in green; between 45%-64.99% of the time, then the number would be displayed in yellow; between 25%-44.99% of the time, then the number would be displayed in orange; and less than 25% of the time, then the number would be displayed in red. See, e.g., FIGS. 1A, 1B, 1C, 1D, 1E.

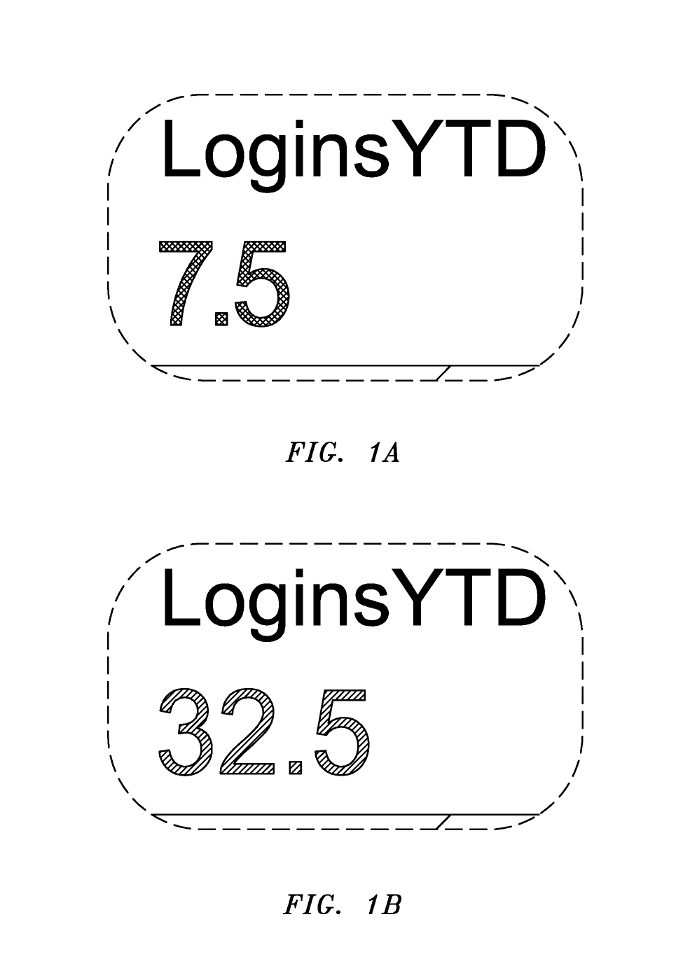

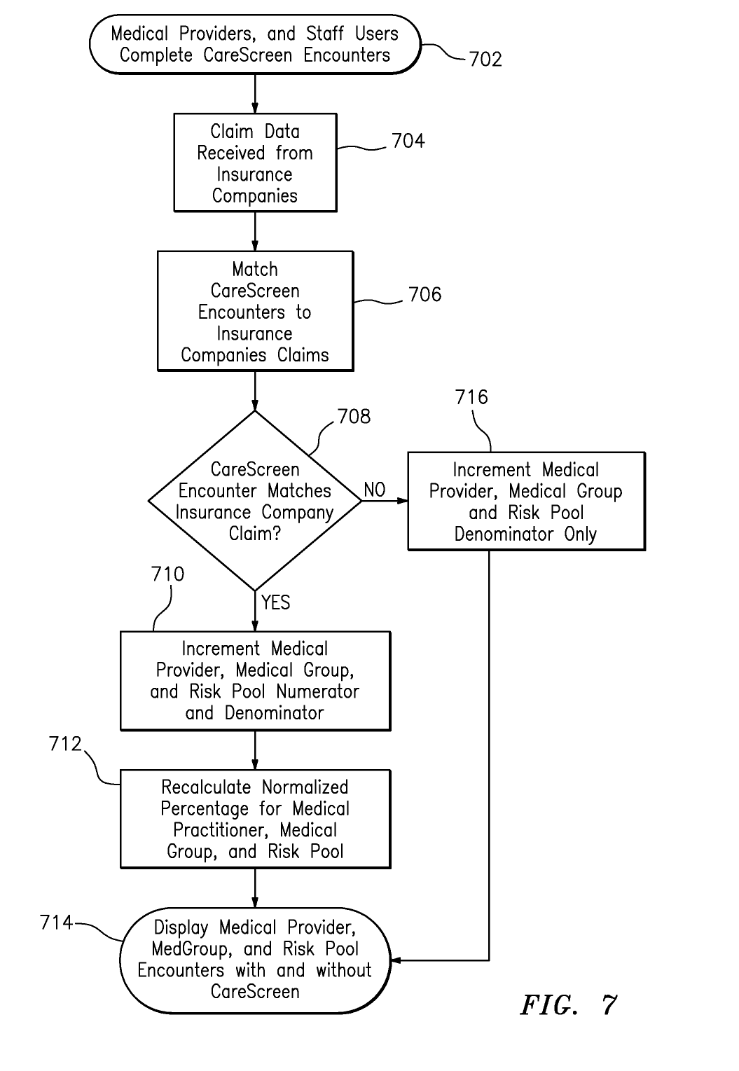

The reader's attention is called to FIG. 2 (relating to Comparison of CareScreen™ Claims to Total Insurance Company Claims), and to FIG. 7 (relating to Comparison of CareScreen™ Claims to Total Insurance Company Claims). The general flow of calculations required for FIG. 2 is depicted as a flowchart on FIG. 7, blocks 702-716. The user accesses the information by clicking on the CSVMD “YTD Usage” tab 202. Then, the first parameter in FIG. 2 is captioned “InsCo” (referenced at 204). “InsCo” is shorthand notation for “Insurance Company” and the entry under this caption is one or more insurance company codes representing insurance companies accepted by a medical practitioner. The remaining values in each row are peculiar to the identified insurance company. The next parameter in FIG. 2 is captioned “% Done” (referenced at 206). “% Done” displays the percentage of all patients seen by a medical practitioner using CareScreen™ software. In other words, it displays the percentage of all encounters (all patients seen) for a given medical practitioner that were done on a CareScreen™ encounter form and entered into the CareScreen™ software system. The insurance company bills for all encounters whether or not they have been entered into CareScreen™. To determine the “% done” CareScreen™ records are compared with insurance company records to see how many CareScreen™ encounters match (FIG. 7, blocks 702-716). The percentage of matching records is calculated as follows:

% Done=CSencounters/Allencounters×100

Where:
CSencounters=all encounters for the medical practitioner using CareScreen™ whose Patients subscribe to the corresponding insurer; and
Allencounters=all encounters by all methods whether or not entered into CareScreen™ for the medical practitioner whose Patients subscribe to the corresponding insurer;

“Missed” 208 displays the percentage of patient encounters not entered into CareScreen™ software. It is calculated as follows: % Missed=100% minus % Done.

MedGroup 210 is the percentage of all encounters for a given medical group whose patients subscribe to the corresponding insurer that were done on a CareScreen™ encounter form and entered into the CareScreen™ software system. It is calculated as follows:

MedGroup=CSencounters/Allencounters×100

Where:
CSencounters=all encounters for the medical group using
CareScreen™ whose Patients subscribe to the corresponding insurer; and
Allencounters=all encounters by all methods for the medical group whose Patients subscribe to the corresponding insurer.

Risk Pool 212 displays the percentage of all patients seen by all medical practitioners in the insurance company's risk pool, where the medical providers used a CareScreen™ encounter form and entered data into the CareScreen™ software system. It is calculated as follows:

MedGroup=CSencounters/Allencounters×100

Where:
CSencounters=all encounters for the risk pool using CareScreen™ whose Patients subscribe to the corresponding insurer; and
Allencounters=all encounters by all methods for the risk pool whose Patients subscribe to the corresponding insurer.

Best Practice 214 displays a predetermined acceptable percentage of patients seen by medical practitioners who used CareScreen™ software. For example, if each medical practitioner in a medical group sees on average 15 patients daily, who belong to a particular risk pool, the total number of such patients seen per month would be approximately 300, figuring in vacations and holidays. The Best Practice 214 goal would be 100% use of CareScreen™ for seeing those 15 patients yesterday or those 300 patients each month.

Each of the percentage values in FIG. 2, % Done (referenced at 206), MedGroup 208, and Risk Pool 212 are displayed in a color (not shown) corresponding to how each respective value compares with the best practice.

This is another example of how color coding can be used—this time for MedGroup 210. If CareScreen™ software was used in the course of treating patients during the current month: above 75% of the time, then the percentage would be displayed in blue; between 55%-75% of the time, then the percentage would be displayed in green; between 45%-54.99% of the time, then the percentage would be displayed in yellow; between 25%-44.99% of the time, then the percentage would be displayed in orange; and less than 25% of the time, then the percentage would be displayed in red.

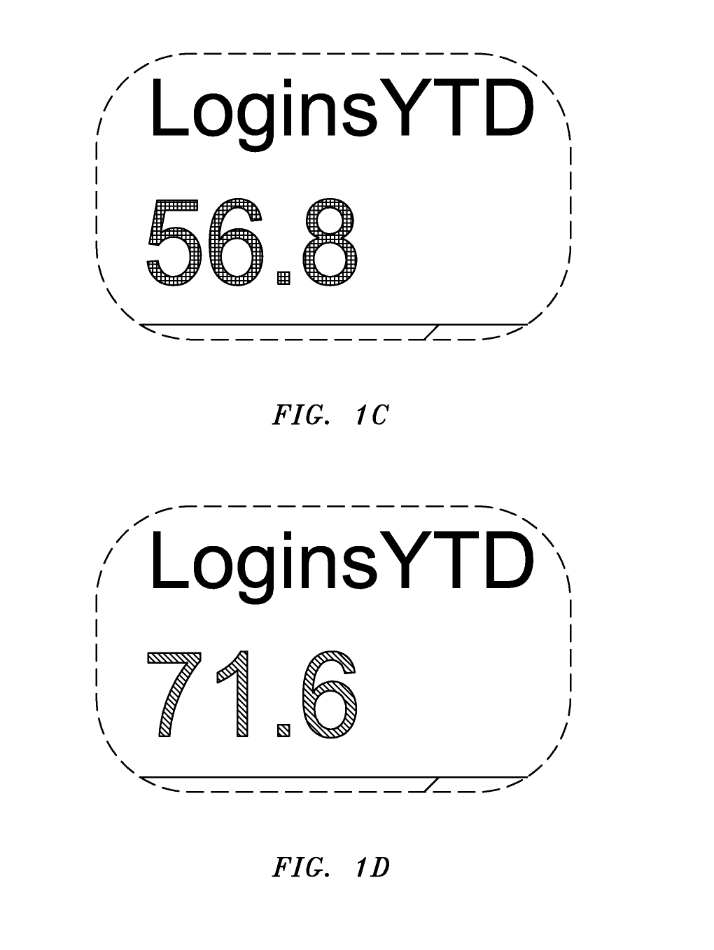

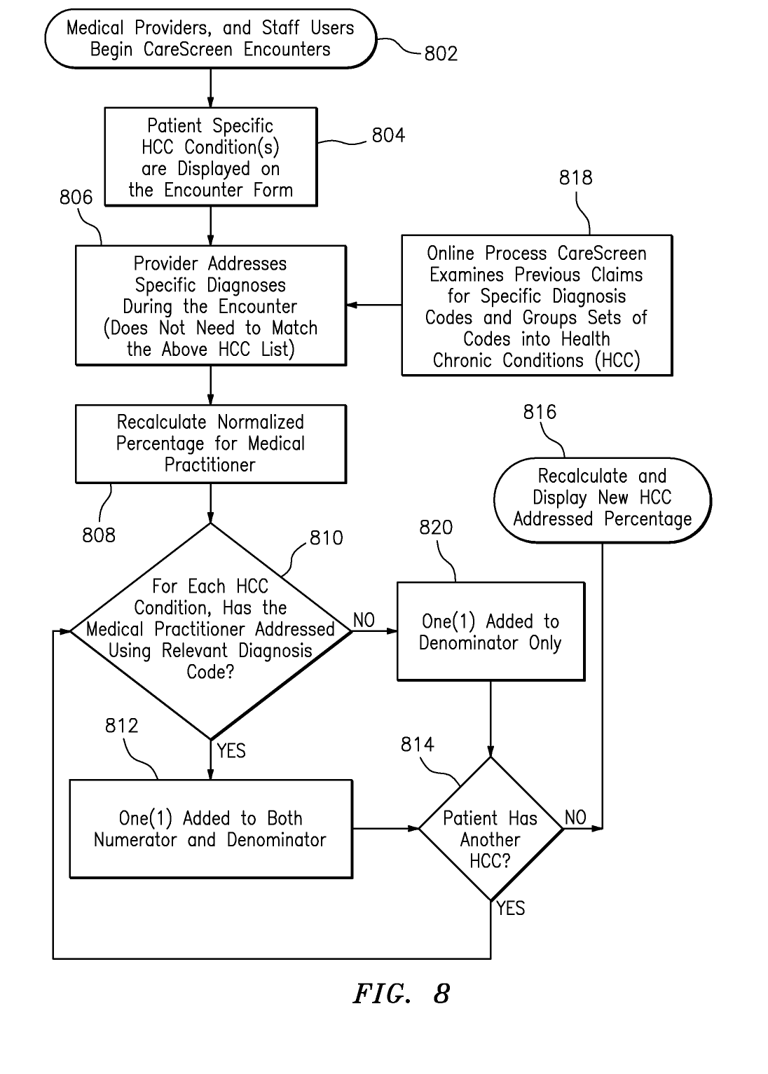

The reader's attention is called to FIG. 3 (relating to Addressing Chronic Condition), and to FIG. 8 (relating to Medical Practitioner Percentage of Chronic Conditions Addressed). The general flow of calculations required for FIG. 3 is depicted as a flowchart on FIG. 8 (relating to Login History (Blocks 802-820)). The user accesses the information by clicking on the CSVMD “HCCs Addressed” tab 302. The HCCs Addressed tab 302 displays the percentage of all health chronic conditions (“HCCs”) addressed by a medical practitioner as compared with the number of possible HCCs that could have been addressed during an average encounter. HCCs are important in the insurance company's determination of future coverage needs; therefore, it is important that the medical practitioner or staff user enters such conditions into CareScreen™ during or at the conclusion of any encounter. The displayed HCCs Addressed value is the percentage derived from comparing the number of times an HCC was entered into CareScreen™ with the number of times an HCC could have been entered.

% HCCs addressed/visit=HCCs Addressed/(HCCs Addressable)

Where:
HCCS Addressed=the total number of HCCs entered into CareScreen™ by the medical practitioner during all patient visits; and
HCCs Addressable=the total number of HCCs that could have been addressed by the medical practitioner as indicated by a review of insurance company records covering all patient visits.

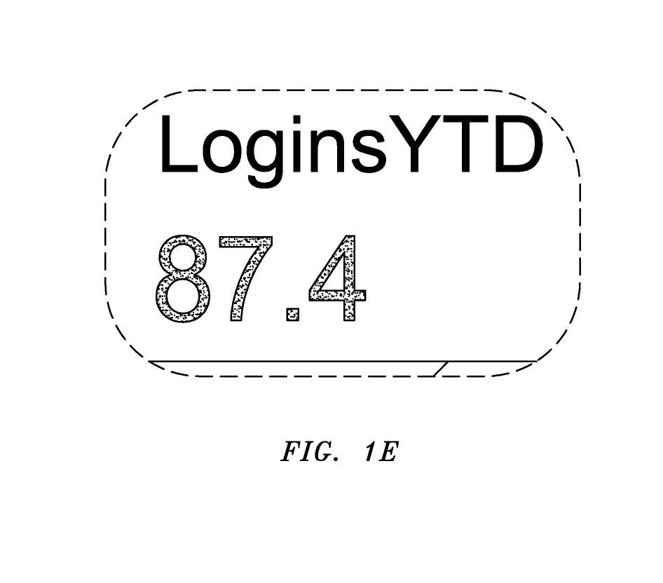

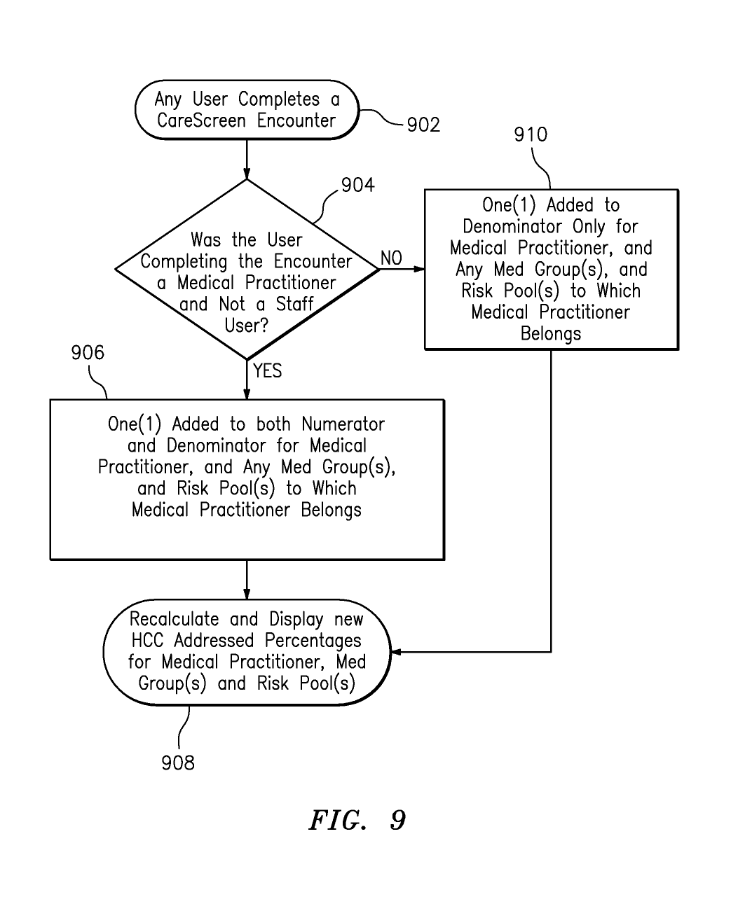

The reader's attention is called to FIG. 4 (relating to CareScreen™ Encounters—Provider usage Versus Staff Usage) and to FIG. 9 (relating to Medical Practitioner Versus Staff Usage of CareScreen™ Encounter Form). The general flow of calculations required for FIG. 4 is depicted as a flowchart on FIG. 9 (Blocks 902-910). The user accesses the information by clicking on the CSVMD “Functional Use, Encounters” tab 402. Values displayed on this tab are concerned with how often encounter forms are completed by staff users as opposed to medical practitioners.

“User ID”, referenced at 404, identifies the current user (a medical practitioner) by number. “#Enc submitted MTD”, referenced at 406, displays the number of encounter forms submitted during the current month by the relevant medical practitioner and his or her staff users. The value is determined by counting.

“% Enc submitted MTD”, referenced at 408, displays a percentage of encounter forms completed by the medical provider as compared with the total number of encounter forms completed by both the provider and the provider's staff users during the current month. It is calculated as follows:

% Enc Submitted YTD=[MPNS]_{CM}/(#Enc submitted MTD)×100

Where:
MPNS_{CM}=the number of encounter forms submitted by the medical practitioner during the current month; and
# Enc Submitted MTD=as defined above.

This screen displayed results, as can all others, be color coded. For example, if each medical practitioner in a medical group sees on average 15 patients daily, who belong to a particular risk pool, the total number of such patients seen per month would be approximately 300, figuring in vacations and holidays. The Best Practice goal would be 100% use of CareScreen™ digitized encounter forms for seeing those 300 patients during the current month.

If CareScreen™ software was used by that medical practitioner, during the last month: above 75% of the average (i.e., 75% of 300), then the percentage could be displayed in blue; between 60% and 74.99%, then the percentage could be displayed in green; between 45% and 59.99%, then the percentage could be displayed in yellow; between 25%-44.99%, then the percentage could be displayed in orange; and less than 25%, then the percentage could be displayed in red.

“#Enc submitted YTD”, referenced at 410, displays the number of encounter forms submitted during the current year by the relevant medical practitioner and his or her staff users. The value is determined by automatically counting.

“% Enc submitted YTD”, referenced at 412, displays the percentage of encounter forms completed by the provider as compared with the total number of encounter forms completed by both the provider and the provider's staff users during the current year. That is the number of encounter forms submitted during the current year, which the medical practitioner completed, divided by the total number of encounter forms submitted by the medical practitioner and his or her staff users during the same month, calculated as follows:

% Enc Submitted YTD=[MPNS]_{CY}/(# Enc submitted YTD)×100

Where:
MPNS_{CY}=the number of encounter forms submitted by the medical practitioner during the current year; and
# Enc Submitted YTD=as defined above.

“MedGroup” tabs 414, 416, 418, 420 display the participation rates for all medical practitioners in the medical groups or healthcare institutions to which the medical practitioner belongs. Calculated as follows:

MedGroup=MPEF/AEF×100
Where:
MPEF=Number of Encounter forms submitted by all medical practitioners in the medical group; and
AEF=Total number of Encounter forms submitted by all medical practitioners and their staff users in the medical group.

“Risk Pool” 422, 424, 426 displays the participation rate for all medical practitioners in the risk pools to which the medical practitioner belongs. Calculated as follows:

Risk Pool=MPEF/AEF×100

Where:
MPEF=Number of Encounter forms submitted by all medical practitioners in the risk pool; and
AEF=Total number of Encounter forms submitted by all medical practitioners and their staff users in the risk pool.

Best Practice 428 is a preordained figure representing the percentage that is considered satisfactory. The value is arbitrarily assigned.

Each of the percentage values in FIG. 4 are automatically displayed in a color corresponding to how each respective value compares with the Best Practice 428. Though not shown, a value in: red indicates significantly below the Best Practice; yellow indicates slightly below the Best Practice; green indicates above the Best Practice; and blue indicates significantly above the Best Practice.

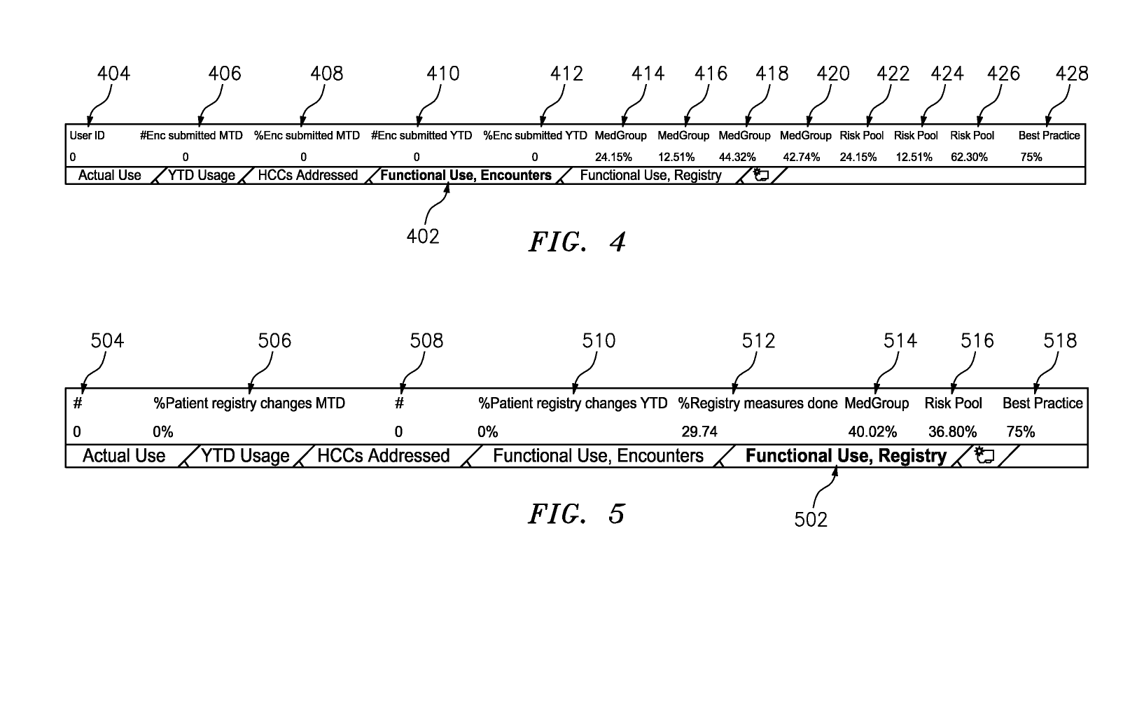

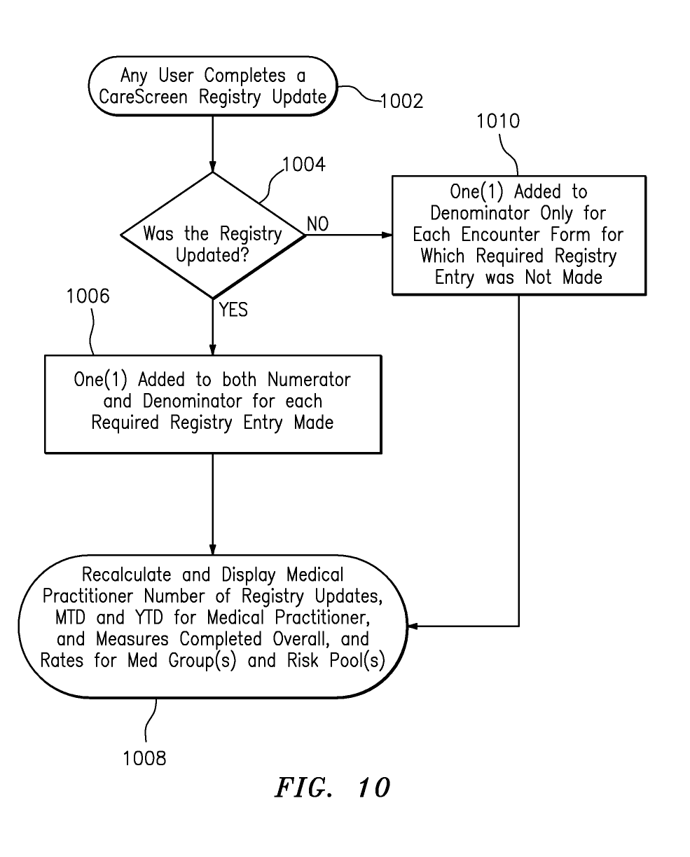

The reader's attention is called to FIG. 5 (relating to Registry Usage). The general flow of calculations required for FIG. 5 is depicted as a flowchart on FIG. 10 (relating to CareScreen™ Registry Usage), at blocks 1002-1010. The user accesses the information by clicking on the CSVMD “Functional Use, Registry” tab 502. Values displayed on this tab are concerned with how often “measures” are entered as required into the CareScreen™ Registry.

Reference number 504 refers to the number of patient registry changes that have been made during the current month. The value is determined by counting.

“% Patient registry changes MTD” (referenced at 506) displays the percentage of registry changes that were made as compared to the number that could have been made during the current month calculated as follows:

% Patient registry changes MTD=ND/NP×100

Where:
ND=Number of Registry Changes that were made during the current month; and
NP=Number of required registry changes appearing on encounter forms during the current month.

Reference number 508 refers to the number of patient registry changes that have been made during the current year. The value is determined by counting.

“% Patient registry changes YTD” (referenced at 510) displays the percentage of registry changes that were made as compared to the number that could have been made during the current year calculated as follows:

% Patient registry changes YTD=ND/NP×100

Where:
ND=Number of Registry Changes that were made during the current year; and
NP=Number of required registry changes appearing on encounter forms during the current year.

“% Registry Measures Done” (referenced at 512) displays the overall percentage of all registry updates have been completed by the medical practitioner and the medical practitioner's staff users, as compared with the percentage that could have been completed. That is the percentage of registry measures that were entered into the CareScreen™ Registry as compared with the number of measures appearing on all of the medical practitioners encounter forms for the period calculated as follows:

% Registry measures done=ND/NP×100

Where:
ND=Number of Registry measures updated; and
NP=Number of registry measures requiring updating appearing on encounter forms.

MedGroup 514 displays the percentage of all registry updates entered into the CareScreen™ Registry for all medical practitioners in the medical group as compared with the number of such entries required. It is calculated as follows:

% MedGroup=ND/NP×100

Where:
ND=Number of registry measures updated for all medical practitioners in the medical group; and
NP=Number of registry measures requiring updating appearing on encounter forms for all medical practitioners in the medical group.

Risk pool 516 displays the percentage of all registry updates entered into the CareScreen™ Registry for all medical practitioners in the medical group as compared with the number of such entries required.

% Risk Pool=ND/NP×100

Where:
ND=Number of registry measures updated for all medical practitioners in the medical group; and
NP=Number of registry measures requiring updating appearing on encounter forms for all medical practitioners in the medical group.

Best Practice 518 displays a preordained percentage value above which the percentage of registry updates entered is considered satisfactory.

Applicant's preferred method can be thought of broadly as comprising: continuously and automatically auditing the extent to which a medical practitioner uses (e.g., refers to and/or enters data in) a digital Superbill, in the course of treating patients, by: automatically and continuously comparing how many times a digital Superbill was used by the medical practitioner over a particular time period, in the course of treating patients, with how many patients the medical practitioner saw over the time period; and displaying digitally-generated, color-coded, audit results on a computer screen, wherein different colors indicate different extents of use of the digital Superbill.

It should be understood by those skilled in the art that obvious modifications can be made to the description above without departing from the spirit of the invention. For example, though Applicant's method is disclosed as being used with CareScreen™ software, this method could be used with other medical software dealing with, at least partly, digital Superbills. Consequently, reference should be made primarily to the appended claims rather than the foregoing description to determine the scope of the invention.

What is claimed is:

1. A method comprising:
a. continuously and automatically auditing the extent to which a medical practitioner uses a digital Superbill, in the course of treating patients, by:
i. automatically and continuously comparing how many times a digital Superbill was used by the medical practitioner over a particular time period, in the course of treating patients, with how many patients the medical practitioner saw over the time period; and
ii. displaying digitally-generated, color-coded, audit results on a computer screen, wherein different colors indicate different extents of use of the digital Superbill.

2. The method of claim 1 wherein the different colors indicate:
a. when the Superbill use is below the preselected number; and
b. when the Superbill use is above the preselected number;

3. The method of claim 1 wherein the color-coded audit results are displayed, as screen displays, to a medical director.

4. The method of claim 1 wherein the color-coded audit results are displayed, as screen displays, to a physician.

5. The method of claim 1 wherein the color-coded audit results are displayed, as screen displays, to a physician's assistant.

6. A method comprising:
a. continuously and automatically auditing the extent to which a medical practitioner uses a digital Superbill, in the course of treating patients, by:
i. automatically and continuously comparing how many times data was entered into a digital Superbill, over a particular time period, for a patient pool of the medical practitioner with how many patients the medical practitioner treated over the time period; and
ii. displaying digitally-generated, color-coded, audit results as screen displays, wherein different colors indicate different extents of Superbill usage.

7. The method of claim 6 wherein the different colors indicate:
a. when the Superbill use is below the preselected number; and
b. when the Superbill use is above the preselected number.

8. The method of claim 6 wherein the color-coded audit results are displayed, as screen displays, to a medical director.

9. The method of claim 6 wherein the color-coded audit results are displayed, as screen displays, to a physician.

10. The method of claim 6 wherein the color-coded audit results are displayed, as screen displays, to a physician's assistant.

11. The method of claim 6 wherein the color-coded audit results are displayed, as screen displays, to a nurse.
